(19) United States
(12) Patent Application Publication
(10) Pub. No.: US 2017/0316673 A1
(43) Pub. Date: Nov. 2, 2017

(54) Automated Fluid Condition Monitoring Multi-Sensor, Transceiver and Status Display Hub

(71) Applicant: Bryan Gorr, Dallas, TX (US)

(72) Inventor: Bryan Gorr, Dallas, TX (US)

(21) Appl. No.: 15/581,505

(22) Filed: Apr. 28, 2017

Related U.S. Application Data
(60) Provisional application No. 62/425,223, filed on Nov. 22, 2016.
(60) Provisional application No. 62/391,351, filed on Apr. 28, 2016.

(51) Int. Cl. G08B 21/18; G01K 13/02; G01N 27/12; G01N 27/416; G08B 5/22; H04B 1/38

(52) U.S. Cl. CPC G08B 21/182; G01N 27/4167; G08B 5/22; G01K 13/02; G01N 27/12; H04B 1/38

(57) ABSTRACT

Systems and methods may provide for automation of how fluids are monitored. These systems and methods may provide a battery-operated, wireless automated configurable solution to enable insight into various parameters of importance, through a plurality of sensors. By embedding sensors in the fluid tanks, data may be automatically collected at chosen intervals and wirelessly sent to status display screens that can be located anywhere within a facility. This may eliminate the manual time-consuming and expensive process of traditional fluid checks. Thus, fluid condition checks may be wirelessly automated to allow consistent monitoring of accurate fluid readings to control costs, including reduction in part yield, quality reduction and decreased re-work, decrease in required additives to stabilize fluids (biocides, stabilizers and defoaming agents) and high fluid waste (using more than is needed because no awareness of amount used) and disposal costs.

### CROSS REFERENCE TO RELATED APPLICATIONS

This application claims the benefit under 35 U.S.C. §119(e) of U.S. Provisional Patent Application Ser. No. 62/425,223 filed on Nov. 22, 2016, entitled “Fluid Condition Monitoring Multi-Sensor, Transceiver and Status Display Hub,” and U.S. Provisional Patent Application Ser. No. 62/391,351 filed on Apr. 28, 2016, entitled “Fluid Condition Monitoring Wireless Multi-Sensor, Transceiver and Status Display,” which are incorporated by reference in their entirety.

### FIELD OF THE DISCLOSURE

The present disclosure generally relates to automated fluid condition monitoring, and more particularly to a battery-operated, wireless automated fluid condition monitoring using a multi-sensor capable transceiver and status display hub.

### BACKGROUND

Fluid monitoring has traditionally been conducted through a manual process. This can be time-consuming as well as expensive. The process to monitor the fluids can be labor-intensive, with inconsistent data contributing to high levels in fluid condition fluctuations. These fluctuations result in lost earnings to manufacturing companies through reduction in part yield, quality reduction and increases in re-work, increases in required additives to stabilize fluids (biocides, stabilizers and defoaming agents) and high levels of fluid waste (using more than you should because you simply didn't know) and disposal costs.

In addition, ongoing employee exposure to industrial processing and metalworking fluids has resulted in employee health related issues such as dermatitis and chronic bronchial related issues resulting in higher health care premiums, lost production time and high employee turn-over.

The process for monitoring these fluids requires the employee to physically go to the fluid tank and manually obtain a fluid sample. Next, the fluid sample is then checked with various handheld devices and then the fluid sample time and date is manually recorded in a fluid condition log. When a company has multiple tanks, they need to monitor the time and labor spent on maintaining this data log is multiplied times the number of tanks. This results in requiring a dedicated workforce to simply monitor fluid conditions.

### SUMMARY

Embodiments of the present disclosure may provide systems and methods to wirelessly automate how fluids are monitored. These systems and methods according to embodiments of the present disclosure may provide a configurable solution to enable insight into various parameters of importance, through a plurality of sensors. By embedding sensors in the fluid tanks, data may be automatically collected at chosen intervals and wirelessly sent to status display screens that can be located anywhere within a facility. This may eliminate the manual time-consuming and expensive process of traditional fluid checks. Thus, fluid condition checks may be automated to allow consistent monitoring of accurate fluid readings to control costs according to embodiments of the present disclosure.

Embodiments of the present disclosure may provide a fluid monitoring system comprising one or more wireless transceivers connected to at least one configurable sensor connected to at least one fluid tank to monitor and collect data relating to at least one fluid parameter; and a hub that may receive data collected by the at least one configurable sensor, the hub having a status display wherein color-coded status icons associated with the at least one fluid parameter may change color as status of the at least one fluid parameter changes. The at least one configurable sensor may be an individual sensor or a plurality of sensors, which also may be referred to as a sensor pack in some embodiments of the present disclosure. The sensor pack may include a plurality of fluid sensors, a filter membrane cap, and a fluid jet. The at least one fluid parameter may be selected from the group comprising: concentration/Brix, pH, dissolved oxygen, conductivity and temperature. The color-coded status icons may be green—good, yellow—caution, and red—alarm. The hub may include a microprocessor and provides point-to-point data transfer. The hub may operate over a cellular network and transmit data to an online portal. The online portal may display information related to the at least one fluid tank and fluid readings from the at least one configurable sensor, the information selected from the group comprising: an account name, a tank name, a sensor identification, a product, one or more charts associated with the at least one fluid parameter being monitored, and a data log. The one or more wireless transceivers may be battery-operated. The one or more wireless transceivers may include a magnet quick-attach enclosure for attachment to any metallic surface. The one or more wireless transceivers may include a transceiver display and check button to provide on-the-spot fluid checks. The at least one configurable sensor may be selected from the group comprising: a fluid concentration/Brix sensor, a pH sensor, a conductivity sensor, a dissolved oxygen sensor, and a temperature sensor.

Other embodiments of the present disclosure may provide a method for automated fluid monitoring, the method comprising: using at least one configurable sensor connected to at least one fluid tank, monitoring and collecting data relating to at least one fluid parameter; and using one or more wireless transceivers connected to the at least one configurable sensor, transferring data collected by the at least one configurable sensor to a hub, the hub having a status display wherein color-coded status icons associated with the at least one fluid parameter may change color as status of the at least one fluid parameter changes. In an embodiment of the present disclosure, there may be one wireless transceiver per fluid tank, and as many as four sensors may connect to a single fluid tank. The at least one configurable sensor may be an individual sensor or a plurality of sensors. The hub may include a microprocessor and provide point-to-point data transfer. The hub may operate over a cellular network and transmit data to an online portal. The online portal may display information related to the at least one fluid tank, the information selected from the group comprising: an account name, a tank name, a sensor identification, a product, one or more charts associated with the at least one fluid parameter being monitored, a service log, and a data log. The at least one configurable sensor may be selected from the group comprising: a fluid concentration/Brix sensor, a pH sensor, a conductivity sensor, a dissolved oxygen sensor, and a temperature sensor. The at least one fluid parameter may be selected from the group comprising: concentration, pH, dissolved oxygen, conductivity, and temperature.

### BRIEF DESCRIPTION OF THE DRAWINGS

For a more complete understanding of this disclosure, reference is now made to the following description, taken in conjunction with the accompanying drawings, in which:

FIG. 1 depicts a fluid monitoring system according to an embodiment of the present disclosure;

FIG. 2 depicts a shop floor status display according to an embodiment of the present disclosure;

FIG. 3A depicts a transceiver unit and sensor pack according to an embodiment of the present disclosure;

FIGS. 3B and 3C depict transceiver units for connecting individual sensors according to an embodiment of the present disclosure; and

FIGS. 4A and 4B depict certain aspects of remote wireless monitoring according to an embodiment of the present disclosure.

### DETAILED DESCRIPTION

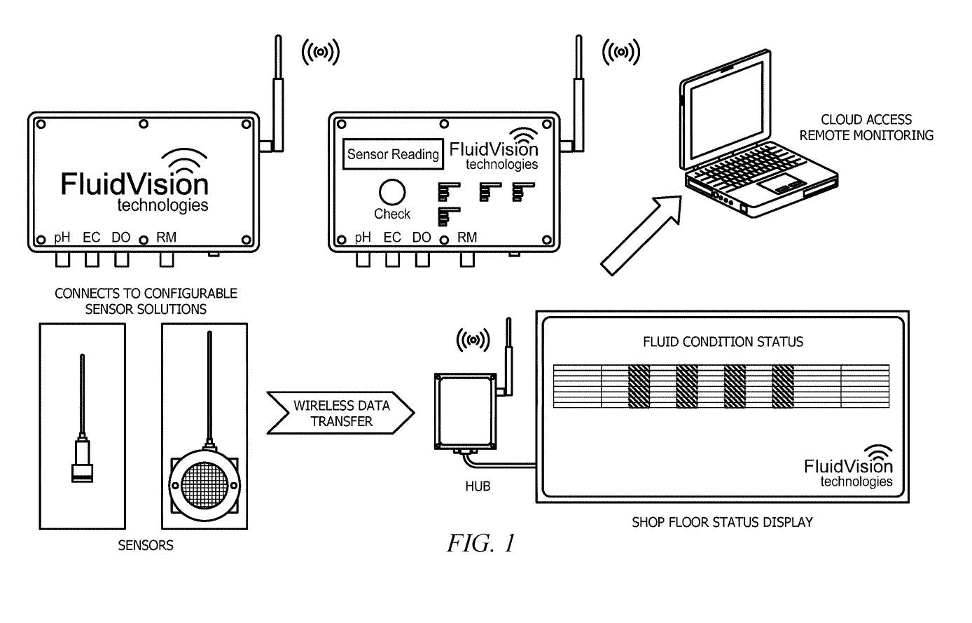

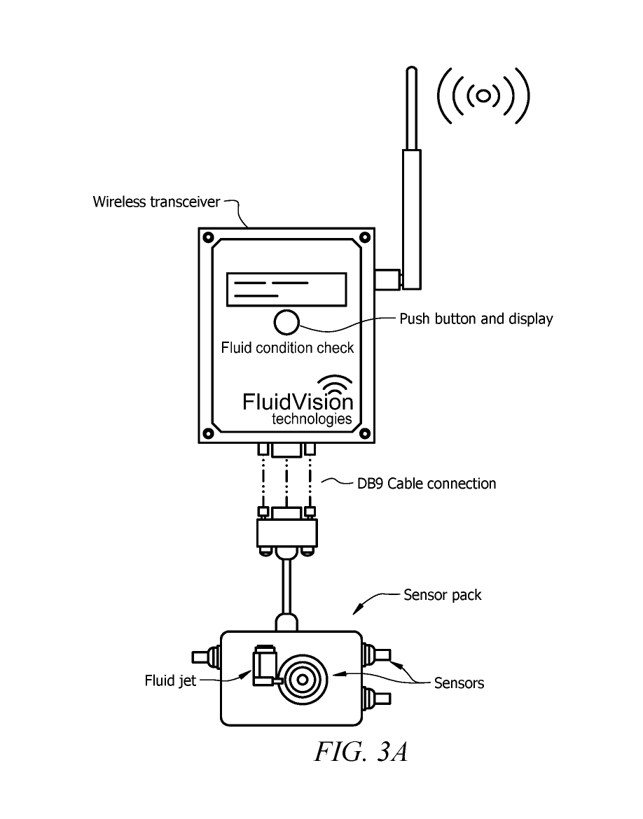

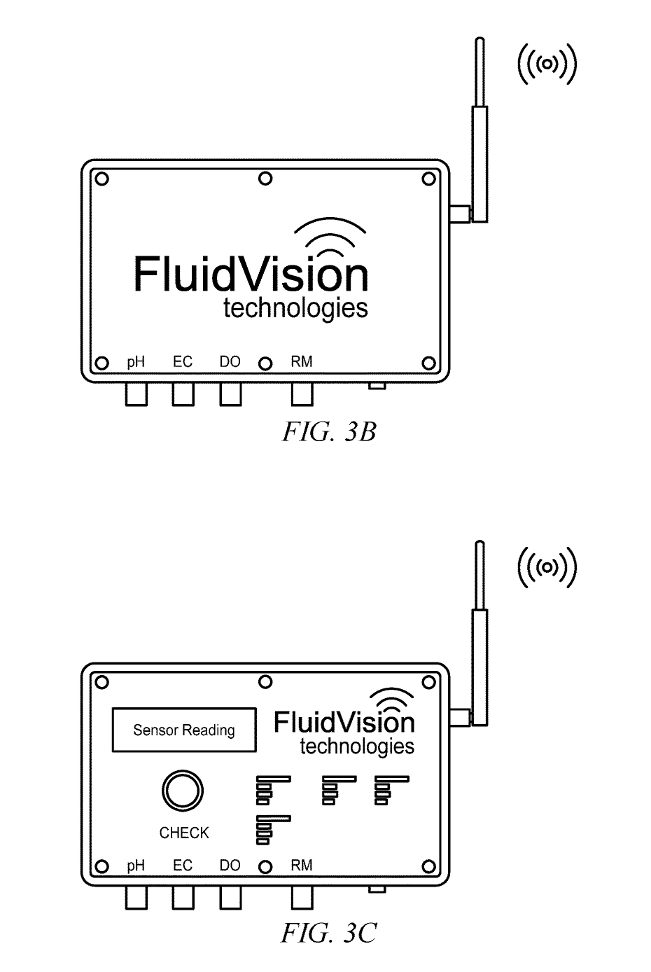

Embodiments of the present disclosure may provide an automated fluid condition monitoring multi-sensor, transceiver and status display hub. A wireless automated configurable multi-sensor pack may utilize a plurality of fluid sensors and at least one transceiver for the monitoring of fluid conditions. FIG. 1 depicts a fluid monitoring system according to an embodiment of the present disclosure. One or more wireless transceivers may connect to configurable sensor solutions. These sensor solutions may include one or more sensors, wherein in some embodiments of the present disclosure, a plurality of sensors may be configured in a sensor pack (FIG. 1) (FIG. 3). Individual sensors may connect to one or more transceivers using a connector. Data collected from the sensor solutions may be transferred wirelessly to a hub, and the hub may provide for status display on the shop floor in some embodiments of the present disclosure. Additionally or alternatively, remote monitoring may be provided through cloud access as depicted in FIG. 1.

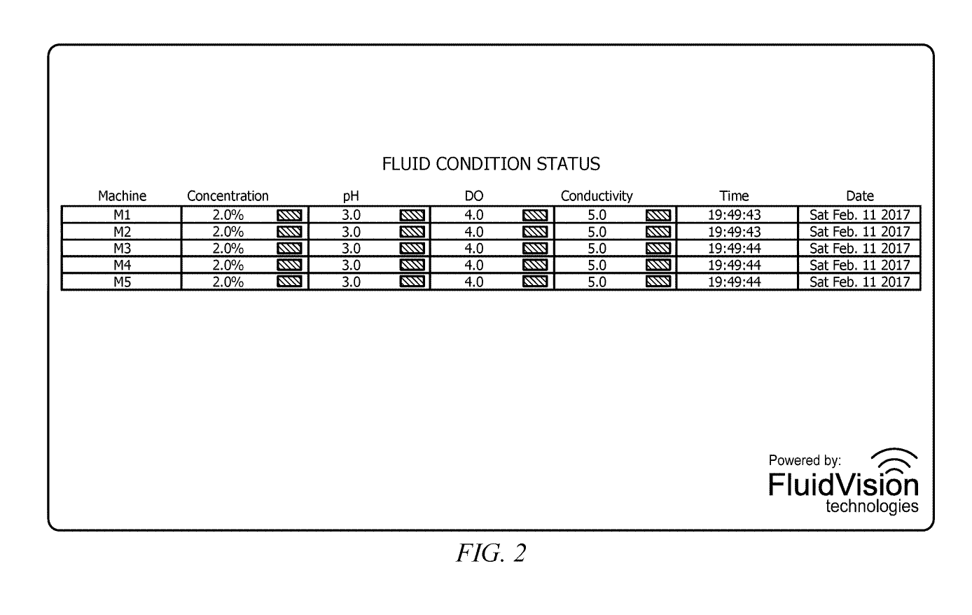

FIG. 2 depicts a shop floor status display according to an embodiment of the present disclosure. The status display may display sensor readings in an easy-to-understand format in embodiments of the present disclosure. This may enable the user to quickly identify changes in fluids. It should be appreciated that the status display may display one or more of the following indicators: the asset number being monitored, the tank/machine name, one or more fluid parameters, color-coded icons (i.e., green/yellow/red indicators as fluid levels change), and date and time stamp. The one or more fluid parameters may include, but are not limited to, concentration/Brix, pH, dissolved oxygen, conductivity and temperature. For each of these fluid parameters, there may be a color-coded status icon that may change color as the fluid parameter changes. In some embodiments of the present disclosure, the status display may display each of the above-identified indicators; however, there may be other embodiments of the present disclosure wherein more or fewer of the above-identified indicators may be displayed. It should be appreciated that there may be embodiments of the present disclosure wherein assets may not be numbered (i.e., assets may be lettered or otherwise named). Regardless, it should be appreciated that some identifier may be included on the status display to identify each asset being monitored in embodiments of the present disclosure. Also, it should be appreciated that there may be embodiments of the present disclosure wherein color-coded icons may not be used at all or different color coding may be used. For example, there may be embodiments of the present disclosure wherein health of a fluid can be defined by indicating ranges. In some embodiments of the present disclosure, these ranges may be captured as numeric ranges with visual quick reference identifier icons that change color as the fluid condition changes (i.e., Green—Good/Yellow—Caution/Red—Alarm may be displayed to indicate changes in fluid conditions).

It should be appreciated that the status display hub, including the shop floor status display, may be considered the server of the system, and it may house the system microprocessor as well as the wireless device. In some embodiments of the present disclosure, the status display hub may connect approximately 1,000 transceiver units. The status display hub may provide point-to-point data transfer with cellular capability according to embodiments of the present disclosure, and in some embodiments of the present disclosure, the status display hub may provide cellular-capable units fitted with IOT SIM cards. The status display hub may include at least one HDMI connector that may allow a non-internet-connected or non-cellular status display hub to connect to any monitor according to embodiments of the present disclosure. It should be appreciated that the hub may be cellular in some embodiments of the present disclosure so as to transmit data to an online portal; however, there may be other embodiments of the present disclosure where the hub may use a microprocessor and thus would be non-cellular (i.e., set up to do a “point-to-point” data transfer). The non-cellular mode may be needed in facilities that may have strict regulations on transmission of data over a cellular network, such as military contractor facilities. Accordingly, there may be embodiments of the present disclosure where a user may be presented with two options for the hub: (1) the user may use the hub to connect to a cloud-based service (i.e., a cellular connection); or (2) the user may use the hub to power and run the microprocessor that may be used to run the shop floor status display. Thus, the customer may use a cellular (i.e., connected) device or a non-cellular point-to-point data transfer unit that may be wired in embodiments of the present disclosure. The status display hub may provide for automatic boot-up when powered on and may provide for automatic reboot by power outage in embodiments of the present disclosure.

FIG. 3A depicts a transceiver unit and sensor pack according to an embodiment of the present disclosure. A sensor pack according to embodiments of the present disclosure may include a plurality of fluid sensors as well as a filter membrane cap and fluid jet to aid in the reliability of the concentration/brix sensor. as depicted in FIG. 3A. The sensor pack may include a magnetic backing for easy installation with a plurality of configurable sensor solutions. It should be appreciated that the sensor pack may connect any sensor capable of data transfer, which may include any sensor that may transmit data in UART RS232 format. The modular design of the sensor pack may provide for easy change-out of sensors.

In addition to or in place of the transceiver unit/sensor pack of FIG. 3A, a transceiver unit may be provided that may allow for individual sensors to be connected such as depicted in FIGS. 3B and 3C. These transceivers may allow to connect various sensors directly to the transceivers without a DB9 connection. Accordingly, these transceivers may allow for individual or multi-sensor connection.

FIG. 3B depicts a transceiver that may provide for easy sensor connection through one or more connection points in an embodiment of the present disclosure. In this embodiment of the present disclosure, the transceiver may include a plurality of BNC connectors, a multi-pin connector which may connect the concentration/Brix sensor, temperature sensor and fluid jet as well as a slide switch. The BNC connectors may be used to receive sensors for pH, conductivity (EC) and dissolved oxygen (DO); however, it should be appreciated that more or fewer connectors or different types of sensors may be utilized without departing from the present disclosure. The transceiver depicted in FIG. 3B may be configured for remote sensor calibration. It may provide for wireless data transfer to a hub status display and portal (such as depicted in FIG. 1). The transceiver of FIG. 3B may be battery-operated in some embodiments of the present disclosure, and it may include a magnet “quick-attach” enclosure that may provide for attachment to any metallic surface.

FIG. 3C depicts another transceiver that may provide for easy sensor connection through one or more connection points in an embodiment of the present disclosure. The transceiver of FIG. 3C is depicted as having the same number/type of sensor connection points as described with respect to FIG. 3B. However, in addition, the transceiver of FIG. 3C may provide a transceiver display and “check” button that may allow for on-the-spot fluid checks in some embodiments of the present disclosure. Like the transceiver depicted in FIG. 3B, the transceiver of FIG. 3C may provide for wireless data transfer to a hub status display and portal (such as depicted in FIG. 1). The transceiver of FIG. 3C may be battery-operated in some embodiments of the present disclosure, and it may include a magnet “quick-attach” enclosure that may provide for attachment to any metallic surface.

Regardless whether individual sensors or a sensor pack may be utilized, the plurality of fluid sensors according to embodiments of the present disclosure may include, but are not limited to, fluid concentration/brix sensors, pH sensors, conductivity sensors, dissolved oxygen sensors, and temperature sensors. It should be appreciated that more or fewer sensors may be utilized without departing from the present disclosure. It also should be appreciated that there may be more than one of a fluid sensor type (i.e., more than one pH sensor) that may attach to or communicate with a transceiver to provide data transfer to a status display hub without departing from the present disclosure. While certain sensors have been identified, it should be appreciated that any sensor with data transfer capability may be incorporated into the configurable wireless multi-sensor pack or be provided as an individual sensor for connection to a transceiver without departing from the present disclosure. The plurality of sensors may be integrated onto a single printed circuit board (PCB) according to embodiments of the present disclosure, and it should be appreciated that custom PCBs may be utilized to integrate the plurality of sensors into a multiplexer to switch ports and extract individual sensor data in sequential format.

As discussed above with respect to FIGS. 3B and 3C, at least one transceiver may provide a magnetic backing or a “quick-attach” enclosure for easy installation. That at least one transceiver may be battery-operated in some embodiments of the present disclosure and may provide wireless automated sensor readings and data transfer to a status display hub. The at least one transceiver may provide for localized checking of parameters by inclusion of a push button and display (FIG. 3C); however, other types of inputs and displays may be utilized without departing from the present disclosure.

The at least one transceiver may display sensor readings locally on a character display contained within the at least one transceiver in some embodiments of the present disclosure (FIG. 3C). This may allow localized fluid condition checks with fluid data wirelessly populating the transceiver display when the transceiver “check fluid condition” button is engaged. In some embodiments of the present disclosure, sensor readings may be sent over a wireless connection to a status display hub. It should be appreciated that the sensor readings may be sent using connections other than a wireless connection without departing from the present disclosure. The sensor readings may be sent to a status display hub in predetermined intervals in some embodiments of the present disclosure, and it should be appreciated that the predetermined intervals may be configured by the manufacturer/provider of the at least one transceiver and/or the status display hub. Additionally or alternatively, the predetermined intervals may be configured by the user without departing from the present disclosure. It should be appreciated that the status display hub may be placed in any location, such as within the user's facility, according to embodiments of the present disclosure.

In order to install a system according to embodiments of the present disclosure, the status display hub may be connected to any monitor (i.e., through the Internet or using an HDMI connector) to provide for a shop-floor status display. The sensors and or configurable sensor pack may be connected to a fluid tank below the fluid level line (i.e., the magnetic backing may attach to the metallic tank walls of the tank). The sensors or the configurable sensor pack may then be connected to the transceiver. The at least one transceiver may include a magnetic back that may quickly attached to any metallic surface outside the tank. The at least one transceiver may be connected to one or more sensors and/or a configurable sensor pack pack using a quick connector cable. The at least one transceiver may then be turned on, and automatic data transfer may begin according to embodiments of the present disclosure. It should be appreciated that color-coded icons on the shop-floor status display may change color as the conditions of the fluids fall out of range in some embodiments of the present disclosure.

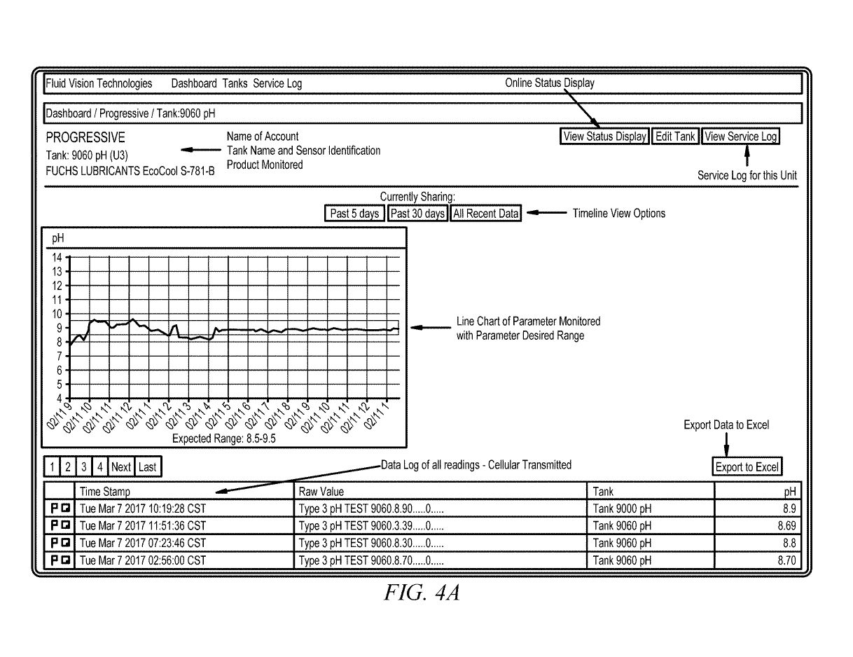

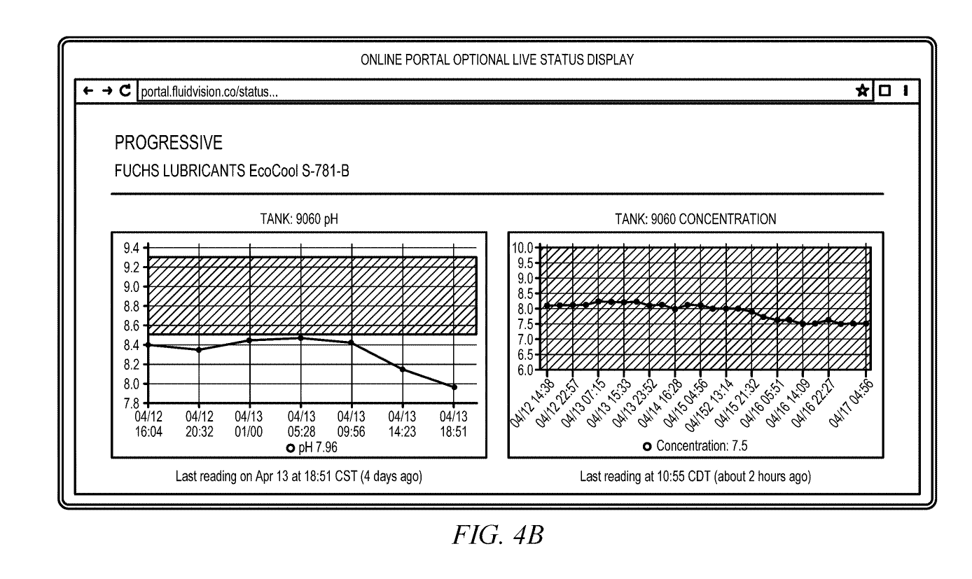

FIGS. 4A and 4B depict certain aspects of remote wireless monitoring according to an embodiment of the present disclosure. More specifically, an online portal may be accessed such as through a user name/password. The online portal may provide account list drill-down, data log visibility (such as through date and time stamps) and line charts, such as those depicted in FIGS. 4A and 4B.

More specifically, FIG. 4A depicts how an online portal may provide information including, but not limited to, the name of the account, the tank name and sensor identification, and the product being monitored. The online portal also may provide a line chart of a parameter being monitored and reflecting the desired range for that parameter; however, other types of charts and graphs may be depicted without departing from the present disclosure. Further, while only one line chart is depicted in FIG. 4A, it should be appreciated that more than one chart or graph may be depicted without departing from the present disclosure. There may be various timeline view options associated with the line chart in embodiments of the present disclosure (i.e., past 2 days, past 20 days, and all recent data). In some embodiments of the present disclosure, a data log of all readings may be displayed (FIG. 4A). For each reading, the data log may include, but is not limited to, time stamp, raw value, tank identification and pH; however, more or fewer data items may be included without departing from the present disclosure. It should be appreciated that a user may elect to export data from the data log (i.e., export to Excel) in some embodiments of the present disclosure. It should be appreciated that data may be reviewed through line chart (or other chart/graph) analysis in embodiments of the present disclosure. The data collected and displayed in the data log on the online portal may be date and time stamped for later analysis. In some embodiments of the present disclosure, trigger values may be set to alert the user when sensor values fall out of range. Alerts may be sent automatically to one or more users via email and/or text message in embodiments of the present disclosure. The online portal also may provide selection mechanisms for a user to view a service log or an online status display in embodiments of the present disclosure.

FIG. 4B depicts an online status display for an online portal according to an embodiment of the present disclosure. As discussed with respect to FIG. 4A, a user may be viewing data concerning a particular account, tank, sensor and product using the online portal and may opt to view the online status display. This online status display may include one or more charts or graphs according to embodiments of the present disclosure. It also should be appreciated that one or more charts or graphs may be depicted with respect to the same fluid parameter or different fluid parameters without departing from the present disclosure. In the embodiment depicted in FIG. 4B, a user may view the pH values recorded on certain dates/at certain times plotted on one graph and then view the concentration readings on a second graph. It should be appreciated that the readings/values depicted on each graph may be taken at different times or over different intervals without departing from the present disclosure. As reflected in FIG. 4B, while both graphs include values starting on April 12, the times when the readings were taken differ. Also, concentration readings have been taken more recently than pH readings as depicted in FIG. 4B.

A fluid monitoring system according to embodiments of the present disclosure may allow a user to control costs. More specifically, there may be lower fluid management labor costs, a reduction in fluid condition fluctuations, a reduction in waste and disposal-related costs, lower tooling costs, and/or a reduction in asset downtime, such as due to corrosion or residue issues.

Embodiments of the present disclosure may provide for further automation of the fluid monitoring process. This may provide consistent and accurate fluid readings at predetermined intervals as well as wireless point-to-point data transfer. Data may integrate with existing MES or OEE software according to embodiments of the present disclosure, and every reading on a data log may be date and time-stamped. Fluid readings may be monitored, and this may result in immediate access to fluid readings at a tank and increased visibility using the shop floor status display. Fluid readings may be monitored through cellular access and remote monitoring in embodiments of the present disclosure.

It should be appreciated that systems and methods according to embodiments of the present disclosure may provide for ease of installation and integration. More specifically, the systems and methods may be plug-and-play with no wires or cables needed, and installation in under approximately 30 minutes.

Accordingly, systems and methods according to embodiments of the present disclosure may provide a visible shop-floor status display to view fluid conditions of each machine on a status display hub anywhere within an operating facility. Remote monitoring may be provided to access account fluid condition data from anywhere at any time. Systems and methods according to embodiments of the present disclosure may be wireless and battery operated to provide industrial-grade wireless performance in a battery-powered package. The systems may be modular to enable fast and easy installation and service. The systems also may be scalable such that when the status display is in place, additional sensor units may arrive pre-calibrated and connect automatically. Customized monitoring also may be provided by including fully configurable sensor units, including but not limited to, individual parameter or multi parameter monitoring by integrating pH, concentration/brix, dissolved oxygen, conductivity, and temperature sensors according to embodiments of the present disclosure.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A fluid monitoring system comprising:
one or more wireless transceivers connected to at least one configurable sensor connected to at least one fluid tank to monitor and collect data relating to at least one fluid parameter; and
a hub that receives data collected by the at least one configurable sensor, the hub having a status display wherein color-coded status icons associated with the at least one fluid parameter change color as status of the at least one fluid parameter changes.

2. The fluid monitoring system of claim 1, wherein the at least one configurable sensor is an individual sensor.

3. The fluid monitoring system of claim 1, wherein the at least one configurable sensor is a sensor pack.

4. The fluid monitoring system of claim 3, the sensor pack comprising:
a plurality of fluid sensors, a filter membrane cap, and a fluid jet.

5. The fluid monitoring system of claim 1, wherein the at least one fluid parameter is selected from the group comprising:
concentration/Brix, pH, dissolved oxygen, conductivity and temperature.

6. The fluid monitoring system of claim 1, wherein the color-coded status icons are green—good, yellow—caution, and red—alarm.

7. The fluid monitoring system of claim 1, wherein the hub includes a microprocessor and provides point-to-point data transfer.

8. The fluid monitoring system of claim 1, wherein the hub operates over a cellular network and transmits data to an online portal.

9. The fluid monitoring system of claim 8, wherein the online portal displays information related to the at least one fluid tank and fluid readings from the at least one configurable sensor, the information selected from the group comprising:
an account name, a tank name, a sensor identification, a product, one or more charts associated with the at least one fluid parameter being monitored, and a data log.

10. The fluid monitoring system of claim 1, wherein the one or more wireless transceivers are battery-operated.

11. The fluid monitoring system of claim 1, wherein the one or more wireless transceivers include a magnet quick-attach enclosure for attachment to any metallic surface.

12. The fluid monitoring system of claim 1, wherein the one or more wireless transceivers include a transceiver display and check button to provide on-the-spot fluid checks.

13. The fluid monitoring system of claim 1, the at least one configurable sensor selected from the group comprising:
a fluid concentration/Brix sensor, a pH sensor, a conductivity sensor, a dissolved oxygen sensor, and a temperature sensor.

14. A method for automated fluid monitoring, the method comprising:
using at least one configurable sensor connected to at least one fluid tank, monitoring and collecting data relating to at least one fluid parameter; and
using one or more wireless transceivers connected to the at least one configurable sensor, transferring data collected by the at least one configurable sensor to a hub, the hub having a status display wherein color-coded status icons associated with the at least one fluid parameter change color as status of the at least one fluid parameter changes.

15. The method of claim 14, wherein the at least one configurable sensor is an individual sensor or a plurality of sensors.

16. The method of claim 14, wherein the hub includes a microprocessor and provides point-to-point data transfer.

17. The method of claim 14, wherein the hub operates over a cellular network and transmits data to an online portal.

18. The method of claim 17, the online portal displaying information related to the at least one fluid tank, the information selected from the group comprising:
an account name, a tank name, a sensor identification, a product, one or more charts associated with the at least one fluid parameter being monitored, a service log, and a data log.

19. The method of claim 14, the at least one configurable sensor selected from the group comprising:
a fluid concentration/Brix sensor, a pH sensor, a conductivity sensor, a dissolved oxygen sensor, and a temperature sensor.

20. The method of claim 14, wherein the at least one fluid parameter is selected from the group comprising:
concentration, pH, dissolved oxygen, conductivity and temperature.
